(19) United States
(12) Patent Application Publication
(10) Pub. No.: US 2009/0303555 A1
(43) Pub. Date: Dec. 10, 2009

(54) CAMERA PLATEN

(75) Inventors: Jonathan Barton, Endicott, NY (US); Wayne M. Blackwell, Chenango Forks, NY (US)

Correspondence Address: Lockheed Martin Corporation;c/o WOLF, GREENFIELD & SACKS, P.C., 600 ATLANTIC AVENUE, BOSTON, MA, 02210-2206, US

(73) Assignee: Lockheed Martin Corporation, Bethesda, MD (US)

(21) Appl. No.: 12/133,112

(22) Filed: Jun. 4, 2008

(51) Int. Cl. H04N 1/04

(52) U.S. Cl. 358/498

(57) ABSTRACT

Methods and apparatus are disclosed for improving the effectiveness with which a line scan camera may read information presented on the surface of an item, such as a flats mail item having name and/or address information printed thereon which is enclosed or partially covered in transparent and/or semi-transparent material. Some embodiments provide a camera platen having a surface area which promotes a smoothing and/or brushing of material covering the information on the surface of a mail item, thereby reducing wrinkles, angulations or deformities in the covering that might otherwise cause shadows and/or glare that could obscure the information. Smoothing and/or brushing may, for example, be achieved using a platen having surface areas formed of materials having different coefficients of friction.

### FIELD OF THE INVENTION

This invention relates generally to line scan camera assemblies which are fixed in a stationary position while objects to be photographed are conveyed past.

### BACKGROUND OF INVENTION

Line scan cameras have been implemented in numerous industrial and commercial settings, such as on high-speed mail sorting systems. Typically, line scan camera assemblies include a camera, fixed in a stationary position behind a viewing area defined at least in part by an aperture formed in a platen. A transport assembly may be used to convey mail items one by one past the viewing area. As individual mail items reach the viewing area, they may be scanned or photographed by the camera. Image data captured by the camera (e.g., a name and address of an intended recipient printed on the surface of the mail item) may be decoded or otherwise processed by a signal processing circuit. Based on the decoded image data, mail items may be sorted into various bins (e.g., according to destination address) for delivery to recipients. If image data on a mail item can not be properly read or decoded, the mail item is typically conveyed to a bin for manual sorting by an operator. It is more costly and time-consuming for mail items to be sorted manually by an operator than to be sorted automatically.

Components of a conventional line scan camera assembly 10 used in a high-speed mail sorting system are shown in FIG. 1. In FIG. 1, mail item 100 is conveyed in direction 101 toward platen 102 in an upright position by belts 110A-110C and 115A-115C. That is, belts 115A-115C are rotated by roller 120 in a clockwise direction as shown in FIG. 1 and belts 110A-110C each travel in a right-to-left direction as shown in FIG. 1, so as to convey mail piece 100 toward platen 102. As mail item 100 is conveyed past platen 102, information on mail piece 100 (e.g., name and address information printed on its surface) is illuminated and presented to a camera (not shown in FIG. 1), disposed on the opposite side of platen 102 from belts 110A-110C, via aperture 135. The camera is designed to capture information on mail item 100 that is visible through aperture 135, and to provide the information to a computer (also not shown in FIG. 1) for decoding.

The force applied to mail item 100 by belts 110A-110C causes mail item 100 to continue past platen 102 toward belts 122A-122C (belts 122B-122C are not shown in FIG. 1). Belts 122A-122C rotate in a clockwise direction as shown in FIG. 1 by roller 125. When the leading edge of mail item 100 reaches belts 122A-122C, force applied by belts 122A-122C and 110A-110C to mail item 100 cause mail item 100 to be conveyed away from platen 102.

Example platen 102 is shown in greater detail in FIG. 2. As described above, platen 102 is constructed and arranged to present information to an accompanying camera (not shown in FIG. 2) via aperture 135. Platen 102 may be affixed to the same surface to which the camera is mounted (e.g., platform 105, FIG. 1) via supports 205 and 215 and bolts 210 and 220, respectively. Platen 102 includes “upstream” surface area 130 and “downstream” surface area 140, which are so designated with respect to aperture 135 along the path traveled by mail items (e.g., mail item 100) past platen 102 as shown in FIG. 2. That is, the leading edge of a mail item conveyed past platen 102 first reaches upstream surface area 130, then crosses aperture 135, then reaches downstream surface area 140.

### SUMMARY OF THE INVENTION

Applicant has appreciated that the physical characteristics of certain types of mail items may detract from a camera's ability to effectively read information on the surface of the mail items (e.g., name and/or address information). For example, “flats” mail items, such as magazines, newspapers, thin packages, catalogs, large envelopes, etc., are often either covered or wrapped in plastic or polyethylene or contained in a windowed enclosure with a clear, transparent or semi-transparent material such as cellophane, polystyrene or glassine covering name and/or address information. Applicants have appreciated that the wrapping, covering or window material may be wrinkled or creased as the mail item is conveyed past the aperture of conventional camera platens. This wrinkling or creasing can cause shadows to be cast on the mail item, or cause light that is directed at the mail item to illuminate name and address information to be reflected toward the camera, creating glare that may reduce the camera's ability to effectively read information on the surface of the mail item. By increasing the camera's ability to effectively read information on the mail item, the platen may make it less likely that the mail item will need to be sorted manually.

Applicant has also appreciated that conveying large volumes of mail items across a conventional camera platen may cause the platen to become worn over time, as the material(s) enclosing mail items may cause abrasion of the platen surface over time. For example, Applicant has appreciated that the paper products in which many mail items are enclosed may cause abrasion on the surface of a camera platen over time.

To resolve these and other issues, some embodiments of the invention provide a platen having a surface across which mail items are conveyed which promotes a smoothing and/or brushing of the material covering the information on the surface of a mail item, such as wrapping that encloses the mail item, the window material that covers information printed on the surface of the mail item, and/or other material. By promoting a smoothing and/or brushing of the material, embodiments of the invention may reduce wrinkles, shadows and/or glare which otherwise might obscure the information on the mail item, and thereby improve a camera's ability to read the information on the mail item, making it more likely that the mail item may be sorted automatically rather than manually.

In some embodiments, this smoothing or brushing effect may be achieved by a platen having a surface area formed of materials having different coefficients of friction. For example, in some embodiments, a platen may include an upstream surface area (e.g., which a mail item may reach before reaching the aperture on the platen) that is formed of materials having different coefficients of friction, so that when a mail item is conveyed over the upstream surface area toward the aperture, the portion(s) formed of material(s) having the higher coefficient(s) of friction create(s) a slight drag on the surface of the mail item, thereby creating a smoothing effect that reduces the shadows and/or glare that might otherwise obscure information on the mail item. The portion(s) formed of the material(s) having the higher coefficient(s) of friction may, for example, be arranged in a pattern on the surface of the platen, so as to promote a brushing effect that may also tend to reduce glare and/or shadows.

In some embodiments, a platen is provided with a surface area that is formed at least in part by materials having sufficient hardness so as to reduce the abrasion that might otherwise be caused by material(s) enclosing mail items over time.

Some embodiments of the invention provide a platen for use in a system comprising a camera and a transport assembly, the camera having a field of view, the transport assembly configured to convey items past the field of view, the items being conveyed along a transport path, the camera being fixed in a stationary position alongside the transport path, the platen comprising an aperture, an upstream surface portion and a downstream surface portion, the aperture being arranged to define the field of view, the upstream and downstream surface portions being disposed substantially adjacent the aperture such that items traveling along the transport path first reach the upstream surface portion, then the aperture and then the downstream surface portion, the upstream surface portion comprising a first upstream surface portion and a second upstream surface portion, the first upstream surface portion being formed of a material which exhibits a higher coefficient of friction than a material from which the second upstream surface portion is formed.

Some embodiments of the invention provide a method for fabricating a platen for use in a system comprising a camera and a transport assembly, the camera having a field of view, the transport assembly configured to convey items past the camera's field of view, the items being conveyed along a transport path, the camera being fixed in a stationary position alongside the transport path. The method comprises acts of: (A) forming an aperture, an upstream surface portion and a downstream surface portion, the aperture arranged to define the camera's field of view, the upstream and downstream surface portions arranged substantially adjacent the aperture; and (B) forming, within the upstream surface portion, a first upstream surface portion using at least a first material and a second upstream surface portion using at least a second material, the first material exhibiting a higher coefficient of friction than the second material.

Some embodiments of the invention provide a method for use in a system comprising a camera, a platen and a transport assembly, the camera having a field of view, the transport assembly configured to convey items along a transport path past the field of view, the platen having an aperture defining the field of view, the platen further comprising surface areas disposed upstream and downstream the aperture along the transport path, respectively, at least one of the items having a surface on which information is presented, the information being covered by a covering. The method comprises: (A) causing the at least one of the items to contact a first portion of the upstream surface area formed of a first material and a second portion of the upstream surface area formed of a second material, the first material exhibiting a higher coefficient of friction than the second material, so that the first portion exerts a drag on the covering as the at least one of the items is caused to contact the first portion.

### BRIEF DESCRIPTION OF THE DRAWINGS

FIG. 1 depicts components of a conventional transport assembly for conveying mail items across the field of view of a line scan camera;

FIG. 2 depicts an example of a conventional platen which may be fixed in a stationary position along a transport path;

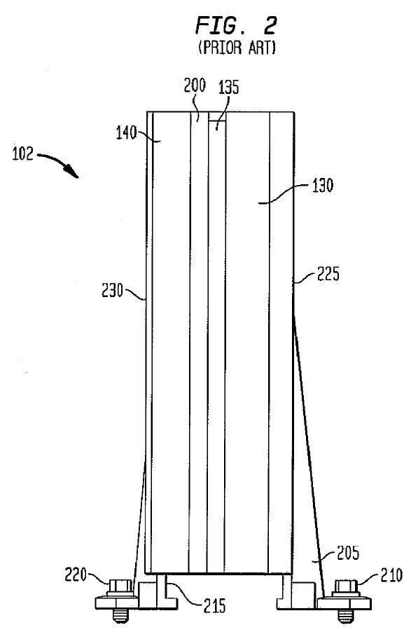

FIG. 3 depicts an example platen having an upstream portion which comprises surface areas formed of materials exhibiting different coefficient of friction, in accordance with some embodiments of the invention;

FIG. 4 depicts an example platen having an upstream portion which comprises a plurality of surface areas formed of materials exhibiting different coefficient of friction, in accordance with some embodiments of the invention;

FIG. 5 is a flow chart depicting an example method for fabricating a platen in accordance with some embodiments of the invention; and

FIG. 6 is a flow chart depicting an example process of using a platen having surface areas formed of materials having different coefficient of friction, in accordance with some embodiments of the invention.

### DETAILED DESCRIPTION

In accordance with some embodiments of the invention, a platen is provided having a surface across which mail items are conveyed which promotes a smoothing and/or brushing of the material covering information on the surface of a mail item, such as the wrapping that encloses the mail item or the window material which covers information printed on the surface of the mail item. This smoothing and/or brushing may reduce angulations or deformities in the material covering information on the mail item that might otherwise cause shadows and/or glare that could obscure the information. As a result, a camera's ability to read the information on the mail item may be improved, thereby making it more likely that the mail item may be sorted automatically rather than manually.

In accordance with some embodiments, this smoothing and/or brushing may be achieved by employing a platen having a surface formed of materials having different coefficients of friction. For example, in some embodiments, a platen may include an upstream surface area formed of a plurality of materials, each having different coefficients of friction. The upstream surface area may, for example, be formed of two materials, one having a higher coefficient of friction than the other. The portion(s) of the upstream surface area formed of the material(s) having the higher coefficient(s) of friction may be arranged so that when a mail item is conveyed across the portion(s), the material(s) having the higher coefficient(s) of friction exert(s) a slight drag on the surface of the material enclosing the mail item. As a result, any angulations or deformities in the surface of the material may be reduced, and any shadows and/or glare that might otherwise obscure the information on the mail item may be minimized just before, or as, the item crosses the aperture.

It should be appreciated that the invention is not limited to employing only two materials exhibiting different coefficients of friction, as any number of materials may be employed. In addition, the invention is not limited to having only one portion formed of the material(s) having a higher coefficient of friction, as any number of portions may be provided. For example, if the platen surface is formed of two materials, one having a higher coefficient of friction than the other, then the surface may include a plurality of portions (e.g., arranged in a pattern) formed of the material exhibiting the higher coefficient of friction. The invention is not limited to any particular implementation.

In some embodiments, the upstream and/or downstream surface area of a platen may be formed at least partially of material(s) having sufficient hardness to reduce abrasion that might otherwise be caused by conveying large numbers of mail items over the platen. For example, the upstream and/or downstream surface area may be formed at least partially of materials) having greater scratch resistance than stainless steel.

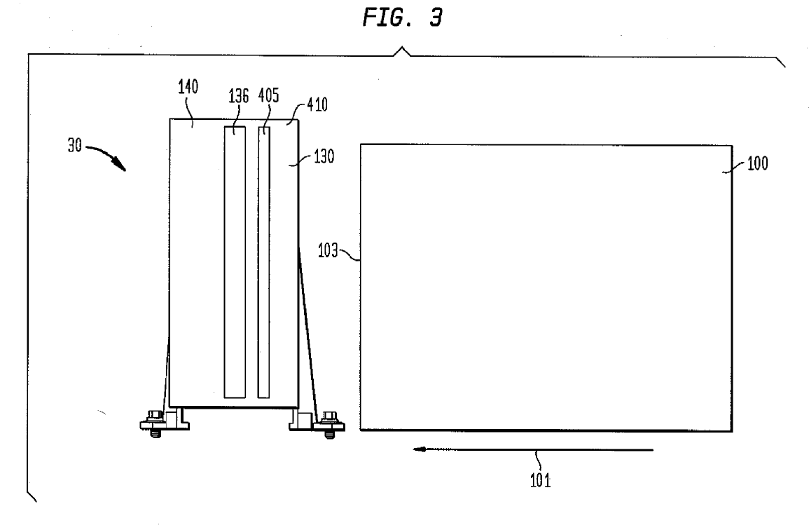

FIG. 3 shows an example platen 30 implemented in accordance with some embodiments of the invention. Platen 30 includes upstream surface area 130 and downstream surface area 140. Upstream surface area 130 includes surface portions 405 and 410. In the example shown, surface portion 405 is formed of a material having a higher coefficient of friction than that from which surface portion 410 is formed. For example, surface portion 405 may be formed of hard nickel, which has a static coefficient of friction of approximately 0.96 against stainless steel, and surface portion 410 may be formed of hard chrome, which has a static coefficient of friction of approximately 0.48 against stainless steel.

In the arrangement shown in FIG. 3, when mail piece 100 is conveyed in direction 101 toward platen 30, leading edge 103 first contacts surface portion 410. As leading edge 103 continues along surface portion 410 in direction 101, it then contacts surface portion 405. Because surface portion 405 is formed of material having a higher coefficient of friction than the material from which surface portion 410 is formed, surface portion 405 may exert a slight drag on the material covering information on mail item 100 (e.g., the wrapping in which mail item 100 is enclosed or the windowing material covering information on mail item 100), due to its comparatively higher coefficient of friction, thereby reducing wrinkles, angulations and other deformities of the material as it approaches aperture 136, and making it less likely that such deformities may cast shadows on information on the surface of mail item 100 or cause glare which might obscure the information and make it less likely that a camera viewing the information via aperture 136 might read the information accurately.

It should be appreciated that an implementation which employs hard nickel and chrome is merely an example, and that the invention is not limited to surface portions formed of any particular material(s). Any suitable material(s) exhibiting different coefficients of friction may be employed. Further, it should be appreciated that the approximately 2:1 ratio of coefficients of friction exhibited by hard nickel and hard chrome is merely exemplary, and that any materials, exhibiting any suitable difference in coefficients of friction, may be employed. The invention is not limited to being implemented in any particular fashion.

In some embodiments, downstream surface area 140 is formed of the same material as surface portion 410, or of other material(s) having a lower coefficient of friction than surface portion 405.

It should be appreciated that surface portion 410 and/or downstream surface area 140 may, for example, be formed of material(s) having low coefficients of friction, so that despite the comparatively high coefficient of friction exhibited by surface portion 405, approximately the same, or less, energy may be required to convey a mail item across platen 30 than across conventional platens. For example, if surface portion 410 and/or downstream surface area 140 were formed of hard chrome rather than stainless steel, which is used on many conventional platens and which exhibits a much higher coefficient of friction than hard chrome, then platen 30 may impose less friction overall than many conventional platens. Thus, the total energy required to convey mail items across a platen implemented in accordance with embodiments of the invention may not be appreciably more than the energy required with many conventional platens. Hard chrome may also provide greater scratch resistance (as measured on the Mohs scale) than stainless steel, which may extend the useful life of the platen and reduce maintenance costs. For example, if surface portion 410 and/or downstream surface area 140 were formed from hard chrome rather than stainless steel, then abrasion of the platen surface by materials enclosing mail items may be significantly reduced.

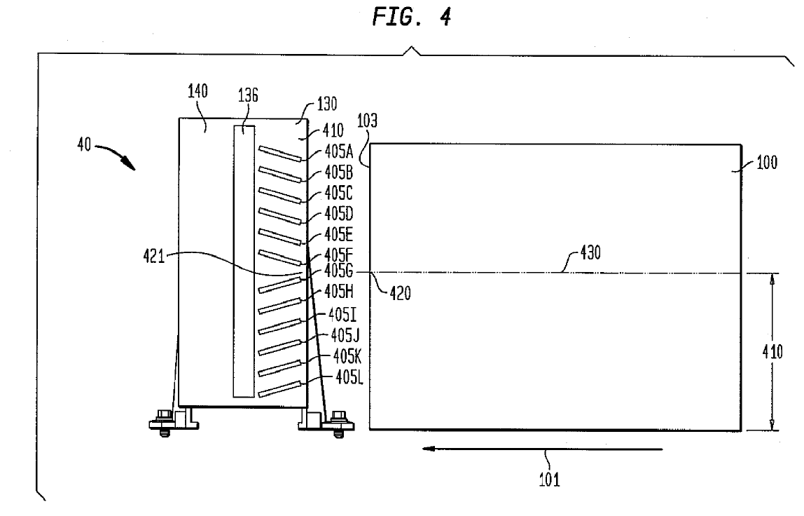

FIG. 4 depicts an alternative embodiment in which a platen 40 has surface area portions, formed of materials with comparatively high coefficients of friction, which are arranged in a pattern. Platen 40 includes upstream surface area 130 and downstream surface area 140. Upstream surface area 130 includes surface portions 405A-405L, arranged in a “herringbone” pattern, and surface portion 410. In the example shown, each of surface portions 405A-405L is formed of a material having a higher coefficient of friction than the material from which surface portion 410 is formed. Each of portions 405A-405L may, for example, be formed of the same material, although the invention is not limited to such an implementation, as a plurality of materials may alternatively be employed.

The pattern into which portions 405A-405L are arranged my create a brushing or smoothing effect that reduces material angulations or deformities, exerting the greatest effect near a specific height on a mail item. In the arrangement shown in FIG. 4, mail item 100 is conveyed in direction 101 toward platen 40, such that leading edge 103 is conveyed toward upstream surface area 130. Leading edge 103 includes segment 420, which is at substantially the same height 410 from platform 105 as is intersection 421 of portions 405F and 405G. Height 410 may, for example, be a height at which information is known to be located on the surface of mail item 100, such as under wrapping enclosing mail item 100 or a window material under which information is printed on mail item 100.

When leading edge 103 of mail item 100 contacts upstream portion 130, segment 420 contacts intersection 421. As mail item 100 continues toward aperture 137, the comparatively high coefficients of friction exhibited by portions 405F and 405G may cause the material enclosing mail item 100 near segment 420 to spread and become taut near height 410, thereby reducing any wrinkles or angulations in the material which might cause shadows and/or glare to obscure information near height 410 on mail item 100. As a result, information near height 410 on mail item 100 may be presented to a camera via aperture 136 in a manner which promotes a more accurate reading of the information. As item 100 continues toward aperture 136, the material covering mail item 100 near height 410 (indicated via dotted line 430) may continue to be spread, such that information on mail item 100 near height 410 may be more accurately read.

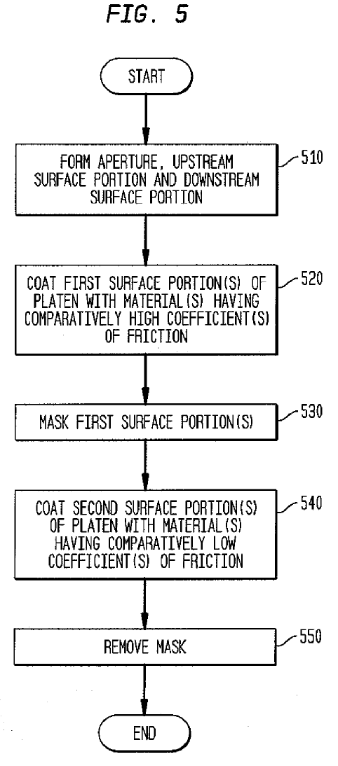

FIG. 5 depicts an example process 500 for fabricating a camera platen in accordance with some embodiments of the invention. In particular, FIG. 5 depicts an example process in which one or more portions on the surface of the platen may be coated with one or more materials which have comparatively high coefficients of friction and other portions of the surface of the platen with materials having comparatively low coefficients of friction.

Process 500 begins with act 510, in which an aperture, upstream surface portion and downstream surface portion are formed. The aperture may be arranged so as to define the field of view for a line scan camera, such as is known in the art. The upstream and downstream surface portions may be disposed substantially adjacent the aperture on the platen. Any technique for forming the aperture, upstream surface portion and downstream surface portion may be employed, as the invention is not limited to any particular implementation.

Process 500 then proceeds to act 520, wherein one or more first portions of the surface of the platen are coated with materials having comparatively high coefficients of friction. Coating of the first surface portion(s) may be performed in any suitable fashion, as the invention is not limited to using any particular technique. The materials used to coat the first surface portion(s) may be any one or more suitable materials, so long as the material(s) used each have a higher coefficient of friction than those used to coat other portions of the surface (discussed further below).

Process 500 then proceeds to act 530, wherein the first surface portion(s) coated in act 520 are masked. Masking may be performed using any suitable technique, as the invention is not limited in this respect. Any of numerous techniques known to those skilled in the art may be employed.

Process then proceeds to act 540, wherein one or more second surface portions are coated with one or more materials exhibiting lower coefficients of friction than the material(s) used to coat the first surface portion(s). In some embodiments, the second surface portion(s) of the platen may represent the remaining surface area of the platen not coated in act 520, such that the completion of acts 520 and 540 causes the entirety of this surface area of the platen to be coated. However, the invention is not limited to such an implementation, as any suitable portion(s) of the surface of the platen may be coated in act 540.

Process 500 then proceeds to act 550, wherein the mask placed in act 530 is removed. As a result of the removal of the mask, the surface of the platen comprises one or more first surface portions, formed of materials having comparatively high coefficients of friction, and one or more second surface portions formed of materials having comparatively low coefficients of friction. As a result, the platen may be capable of smoothing or brushing material covering information on the surface of a mail item, as described above.

Upon the completion of act 550, process 500 completes.

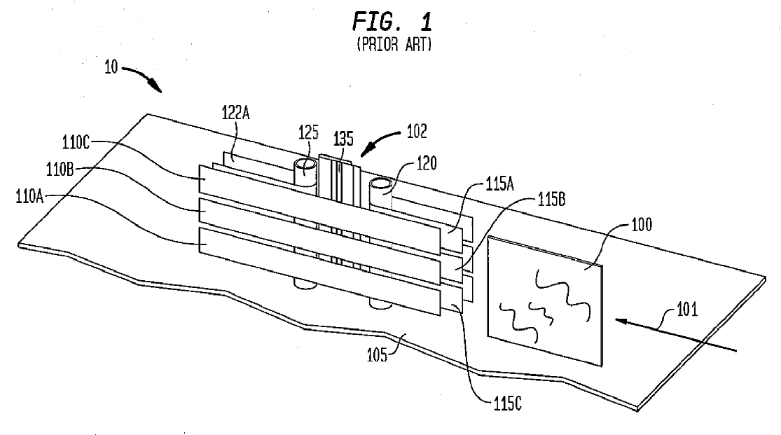

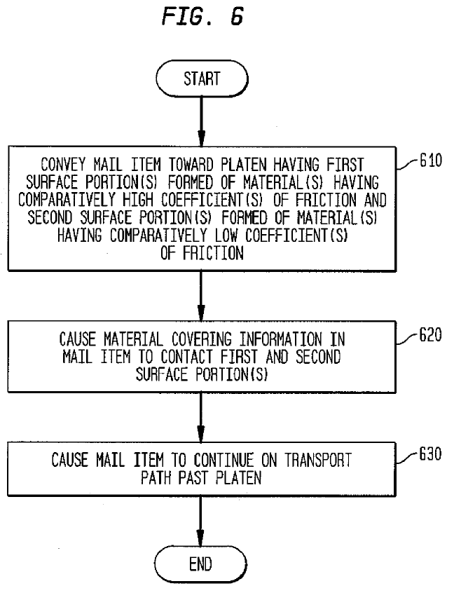

FIG. 6 depicts an example process for using a camera platen constructed and arranged in accordance with embodiments of the invention. Process 600 begins with act 610, wherein a mail item is conveyed toward a platen having one or more first surface portions which are formed of materials having comparatively high coefficients of friction, and one or more second surface portions which are formed of materials having comparatively low coefficients of friction. Conveying a mail item may be performed in any suitable fashion, such as by employing the mail transport assembly described above with reference to FIG. 1.

Process 600 then proceeds to act 620, wherein the material covering information on the mail item is caused to contact the first and second surface portions. Causing the material to contact the first and second surface portions may be performed in any suitable fashion, such as by using the belts 110A-110C and 115A-115C depicted in FIG. 1 to convey the mail item across the surface of the platen. As described above, causing the mail item to contact the first and second surface portions may promote a smoothing and/or brushing effect which may reduce angulations or deformities in the material covering the information on the mail item that might otherwise cause shadows and/or glare that reduce a camera's ability to effectively read the information.

At the completion of act 620, process 600 then proceeds to act 630, wherein the mail item is caused to continue past the platen along the transport path. At the completion of act 630, process 600 completes.

It should be appreciated that the processes described above with reference to FIGS. 5 and 6 are merely examples, and that processes for fabricating and employing a platen defined in accordance with embodiments of the invention may include different acts, include additional acts, omit one or more acts, or differ in some other respect from the processes described above. Embodiments of the invention are not limited to being implemented in any particular manner.

Embodiments of the present invention may therefore include a platen having a surface across which mail items are conveyed which promotes a smoothing and/or brushing of material covering information on the surface of a mail item (e.g., the wrapping that encloses the mail item or the window material which covers information printed on the surface of the mail item), as well as methods for fabricating and using such a platen. The smoothing and/or brushing effect may be achieved via surface portions formed of at least two materials, with at least one having a higher coefficient of friction than another. The surface portion(s) formed of the material having the higher coefficient of friction may be arranged so that when a mail item is conveyed across the portion(s), the material exerts a slight drag on the surface of the material enclosing the mail item, thereby reducing angulations and/or deformities in the surface of the material, which might otherwise limit a camera's ability to effectively read information on the surface of the mail item. As a result of improving the camera's ability to read information on the mail item, embodiments of the invention may make it more likely that the mail item may be sorted automatically rather than manually, which may significantly reduce the overall cost of processing a volume of mail items.

Having now described some illustrative embodiments of the invention, it should be apparent to those skilled in the art that the foregoing is merely illustrative and not limiting, having been presented by way of example only. Numerous modifications and other illustrative embodiments may be contemplated by those of ordinary skill in the art and are believed to fall within the scope of the invention. In particular, many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

Use of ordinal terms such as “first,” “second,” “third,” etc. in the claims to modify a claim element or item in the specification does not by itself connote any priority, presence or order of one element over another or the temporal order in which acts of a method are performed. Rather, these ordinal terms are used merely as labels to distinguish one element having a certain name from another element having a same name, but for the use of the ordinal term, to distinguish the elements.

What is claimed is:

1. A platen for use in a system comprising a camera and a transport assembly, the camera having a field of view, the transport assembly configured to convey an item past the field of view along a transport path, the camera being fixed in a stationary position alongside the transport path, the platen comprising:
an aperture constructed and arranged to define the field of view;
an upstream surface portion; and
a downstream surface portion;
wherein the upstream surface portion and the downstream surface portion are disposed on opposite sides of the aperture and disposed so that an item conveyed along the transport path first reaches the upstream surface portion, then the aperture and then the downstream surface portion; and
wherein the upstream surface portion comprises a first upstream surface portion and a second upstream surface portion, the first upstream surface portion being formed of a material which exhibits a higher coefficient of friction than a material from which the second upstream surface portion is formed.

2. The platen of claim 1, wherein the material from which the first upstream surface portion is formed exhibits a coefficient of friction which is two or more times a coefficient of friction exhibited by the material from which the second upstream surface portion is formed.

3. The platen of claim 1, wherein the material from which the first upstream surface portion is formed exhibits a coefficient of friction which is greater than a coefficient of friction exhibited by the material from which the second upstream surface portion is formed, but which is less than two times the coefficient of friction exhibited by the material from which the second upstream surface portion is formed.

4. The platen of claim 1, further comprising a plurality of first upstream surface portions, wherein the material(s) from which each of the plurality of first upstream surface portions is formed exhibits a higher coefficient of friction than the second upstream surface portion.

5. The platen of claim 4, wherein each of the plurality of first upstream surface portions is formed of a same material.

6. The platen of claim 4, wherein the plurality of first upstream surface portions are arranged into a pattern.

7. The platen of claim 1, wherein the first upstream surface portion is formed at least partially of nickel and the second upstream surface portion is formed at least partially of chrome.

8. The platen of claim 1, wherein at least a portion of the upstream surface portion or of the downstream surface portion is formed of a material exhibiting greater scratch resistance than stainless steel.

9. The platen of claim 1, wherein the item has a surface on which information is presented, the information is covered by a covering, and the first upstream surface portion is constructed and arranged to exert a drag on the covering as the item is conveyed toward the aperture.

10. The platen of claim 1, wherein the item is enclosed in the covering.

11. A method for fabricating a platen for use in a system comprising a camera and a transport assembly, the camera having a field of view, the transport assembly configured to convey an item past the camera's field of view along a transport path, the camera being fixed in a stationary position alongside the transport path, the method comprising an act of:
(A) forming an aperture, an upstream surface portion and a downstream surface portion on the platen, the aperture being formed to define the camera's field of view, the upstream and downstream surface portions being formed substantially adjacent the aperture; and
(B) forming, within the upstream surface portion, a first upstream surface portion from at least a first material and a second upstream surface portion from at least a second material, the first material exhibiting a higher coefficient of friction than the second material.

12. The method of claim 11, wherein the act (B) further comprises:
(B1) coating the first upstream surface portion with the first material;
(B2) masking the first upstream surface portion;
(B3) coating the second upstream surface portion with the second material; and
(B4) removing the mask from the first upstream surface portion.

13. The method of claim 11, wherein the act (B) further comprises forming a plurality of first upstream surface portions using at least a first material.

14. The method of claim 13, wherein at least two of the plurality of first upstream surface portions is formed of a different material.

15. The method of claim 11, wherein the first material exhibits a coefficient of friction which is at least about two times a coefficient of friction exhibited by the second material.

16. The method of claim 11, wherein the act (B) further comprises forming the first upstream surface portion at least partially of nickel and the second upstream surface portion at least partially of chrome.

17. A method for use in use in a system comprising a camera, a platen and a transport assembly, the camera having a field of view, the transport assembly configured to convey an item along a transport path past the field of view, the platen having an aperture defining the field of view, the platen further comprising surface areas disposed upstream and downstream the aperture along the transport path, respectively, the item having a surface, on which information is presented, which is covered by a covering, the method comprising:
(A) causing the covering to contact a first portion of the upstream surface area formed of a first material and a second portion of the upstream surface area formed of a second material:
wherein the first material exhibits a higher coefficient of friction than the second material, so that the first portion of the upstream surface area exerts a drag on the covering as the covering contacts the first portion of the upstream surface area.

18. The method of claim 17, wherein the item is enclosed by the covering.

19. The method of claim 17, wherein the covering is formed of plastic or polyethylene.

20. The method of claim 17, wherein the item is a flats mail item.

21. A camera system configured for installation on a transport assembly operable to convey items along a transport path, the transport assembly being configured to receive a camera system for installation alongside the transport path so that the items are presented for viewing by the camera system as the items are conveyed along the transport path, the camera system comprising:
a camera; and
a platen comprising an aperture, an upstream surface portion and a downstream surface portion, the aperture being constructed and arranged to define a field of view for the camera, the upstream surface portion and the downstream surface portion being disposed on opposite sides of the aperture;
wherein the upstream surface portion of the platen comprises a first upstream surface portion and a second upstream surface portion, the first upstream surface portion being formed of a material which exhibits a higher coefficient of friction than a material from which the second upstream surface portion is formed.

22. The camera system of claim 21, wherein the material from which the first upstream surface portion is formed exhibits a coefficient of friction which is two or more times a coefficient of friction exhibited by the material from which the second upstream surface portion is formed.

23. The camera system of claim 21, wherein the material from which the first upstream surface portion is formed exhibits a coefficient of friction which is greater than a coefficient of friction exhibited by the material from which the second upstream surface portion is formed, but which is less than two times the coefficient of friction exhibited by the material from which the second upstream surface portion is formed.

24. The camera system of claim 21, further comprising a plurality of first upstream surface portions, wherein the material(s) from which each of the plurality of first upstream surface portions is formed exhibits a higher coefficient of friction than the second upstream surface portion.

25. The camera system of claim 24, wherein each of the plurality of first upstream surface portions is formed of a same material.

26. The camera system of claim 24, wherein the plurality of first upstream surface portions are arranged into a pattern.

27. The camera system of claim 21, wherein the first upstream surface portion is formed at least partially of nickel and the second upstream surface portion is formed at least partially of chrome.

28. The camera system of claim 21, wherein at least a portion of the upstream surface portion or of the downstream surface portion is formed of a material exhibiting greater scratch resistance than stainless steel.

29. The camera system of claim 21, wherein the item has a surface on which information is presented, the information is covered by a covering, and the first upstream surface portion is constructed and arranged to exert a drag on the covering as the item is conveyed toward the aperture.
